(19) United States
(12) Patent Application Publication
(10) Pub. No.: US 2004/0074409 A1
(43) Pub. Date: Apr. 22, 2004

(54) Coating device for a rotary printing machine

(76) Inventors: Michael Rother, Rodermark (DE); Jurgen Scholzig, Mainz (DE); Thomas Walther, Hofheim (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/433,682

(22) PCT Filed: Nov. 29, 2001
(86) PCT No.: PCT/EP01/13973

(30) Foreign Application Priority Data
Dec. 5, 2000 (DE) 200 20 703.2
Feb. 13, 2001 (DE) 201 02 450.0

(51) Int. Cl. B41N 1/00

(52) U.S. Cl. 101/395

(57) ABSTRACT

The invention relates to a coating device for a rotary printing machine, especially a sheet printing machine. The aim of the invention is to provide a coating device whose set up time, in particular, is reduced on account of the design thereof and which can be used in a universal manner. The inventive coating device for a rotary printing machine is provided with a printing cylinder (11), a rubber blanket cylinder (9) and a plate cylinder (8) with at least one associated inker unit (15). The inking cylinders (16) of the inker unit can be moved towards and moved away from the plate cylinder. Plate clamping devices are arranged on the periphery of the plate cylinder (8) for fixing a flexible layered body (17) which comprises a supporting layer (18) that can be fixed in the plate clamping devices and at least one compressible rubber layer (19) fixed on top of the supporting layer, in addition to an outer rubber layer (20) fixed on top of the rubber layer. The outer rubber layer is functionally connected to the adjacent rubber blanket cylinder (9).

### DESCRIPTION

The invention pertains to a coating device for a rotary printing machine, in particular a sheet-fed printing machine, according to the preambles of claims 1 and 2.

### STATE OF THE ART

A coating device of this type in the form of an offset printing group for coating materials to be printed in a rotary printing machine is known from DE 197 29 977 A1. In this coating device, the plate cylinder selectively carries a flatbed printing form with an elastic surface or a flexible letterpress printing form. A metering system assigned to the plate cylinder contains a screened inking roller that is arranged such that it can be exchanged (for a wet-inking roller) in the region of the bearing devices of the wet-inking roller, a doctor blade also being associated with the inking roller. During the coating process, the inking unit with its inking rollers is separated from the plate cylinder. In this case, it is advantageous if the printing form that can be held on the plate cylinder is delivered and removed by means of an automated plate clamping and exchanging device.

Another coating device for a rotary printing machine is known from EP 0 620 115 A1. In this case, at least two coating units are provided for the in-line coating of materials to be printed. The first coating unit, as viewed in the conveying direction of the material to be printed, is realized in the form of a flexographic printing unit with a form cylinder that carries a flexible letterpress printing form and is in contact with the printing cylinder that guides the material to be printed, a screened inking roller that is in contact with the form cylinder and a doctor blade that can be screwed down. The second coating unit arranged downstream thereof is realized in the form of a conventional coating unit and, in particular, used for full-surface coating processes.

In the printing industry, flexible rubber blankets are clamped onto the form cylinder for a full-surface coating process. Rubber blankets of this type have a superior damping function and are less expensive than coating plates; these rubber blankets correspond to the rubber blanket used on rubber blankets cylinders of offset printing groups.

A coating cylinder with an inking unit for a coating tower of a sheet-fed rotary printing machine with a sheet guiding cylinder is known from DE 196 13 119 A1. In this case, the coating cylinder is realized in the form of a printing form cylinder with a plate clamping mechanism as it is arranged in the printing groups of sheet-fed offset printing machines. In addition, a plate exchanging device for the coating plates is assigned to the coating cylinder.

One disadvantage in the utilization of rubber blankets in rotary printing machines can be seen in the fact that the clamping of a rubber blanket is very complicated and consequently requires a long set-up time. The disadvantages in the utilization of coating plates are that they have insufficient damping properties, and that coating plates are more expensive than rubber blankets.

### PROBLEM OF THE INVENTION

The invention is based on the problem of developing a coating device of the initially described type which has a design that makes it possible, in particular, to shorten the set-up time and allows a universal utilization of the device.

This problem is solved with the characteristics disclosed in the characterizing portions of claims 1 and 2. Additional developments are disclosed in the dependent claims.

A first advantage of the coating device can be seen in the fact that this device is suitable for processing different types of coating, e.g., printer's varnish, aqueous dispersion coating, UV coating, blister coating or even special inks, for example, metal printing inks or flexographic printing inks.

It is also advantageous that the coating device can be utilized in an offset printing group and/or a coating unit. This device operates in the indirect printing mode in an offset printing group and in the direct printing mode in a coating unit.

The offset printing group for the indirect printing mode conventionally consists of at least one printing cylinder that guides the material to be printed, a rubber blanket cylinder and a plate cylinder, with at least one inking unit associated with the plate cylinder. This embodiment is suitable for waterless offset printing or printing without moistening agents (dry offset printing). For the wet offset printing mode, a moistening unit is arranged upstream of the inking unit as viewed in the rotating direction of the plate cylinder.

The coating unit for the direct printing mode consists of at least one printing cylinder that guides the material to be printed, a form cylinder and a metering system with at least one inking roller.

In this case, a layered body is held on the plate cylinder in the indirect printing mode in an offset printing group (if a rubber blanket cylinder is arranged downstream). The layered body is held on the form cylinder in the direct printing mode in a coating unit.

It is also advantageous that a plate exchanging device is respectively assigned to the plate cylinders in offset printing groups and/or the form cylinders in coating units such that the layered body can be exchanged in an automated fashion in each printing group/coating unit.

Another advantage can be seen in the fact that the layered body consists of a flexible carrier layer, a compressible layer that is arranged on the carrier layer and preferably consists of a rubber layer, as well as a rubber blanket cover layer arranged thereon. The layered body comprises flat layers that are connected to one another and curve in accordance with the cylinder in the clamped-on state.

A layered body has superior damping characteristics (as compared to coating plates), for example, during a [clamping] gap impact, and can be universally utilized for full-surface coating or spot coating processes. In the spot coating mode, it is advantageous that at least one rubber blanket cover layer of the layered body can be stripped off (partially removing the rubber blanket cover layer for the spot coating process).

It is also advantageous that the plate clamping devices of the plate cylinders, as well as the form cylinders, have a uniform design and preferably can be adjusted to a uniform thickness of the printing forms to be clamped thereon, i.e., the thickness of the carrier layer of the layered body corresponds to the thickness of an offset printing plate.

Embodiments

The invention is described in greater detail below with reference to one embodiment. The figures schematically show:

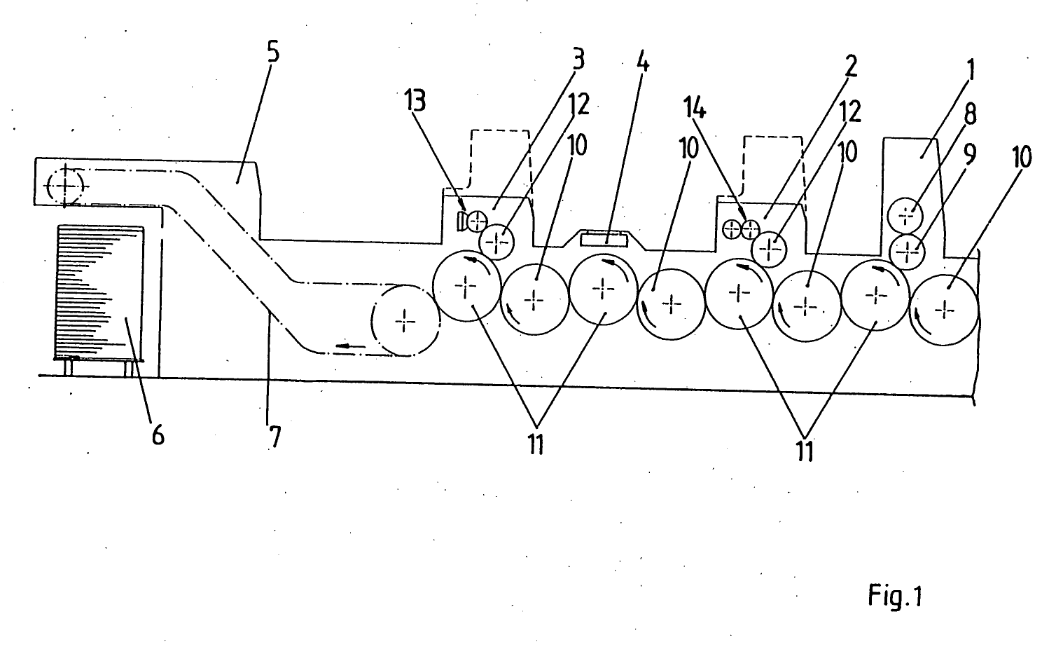

FIG. 1, a printing machine with offset printing groups and coating units,

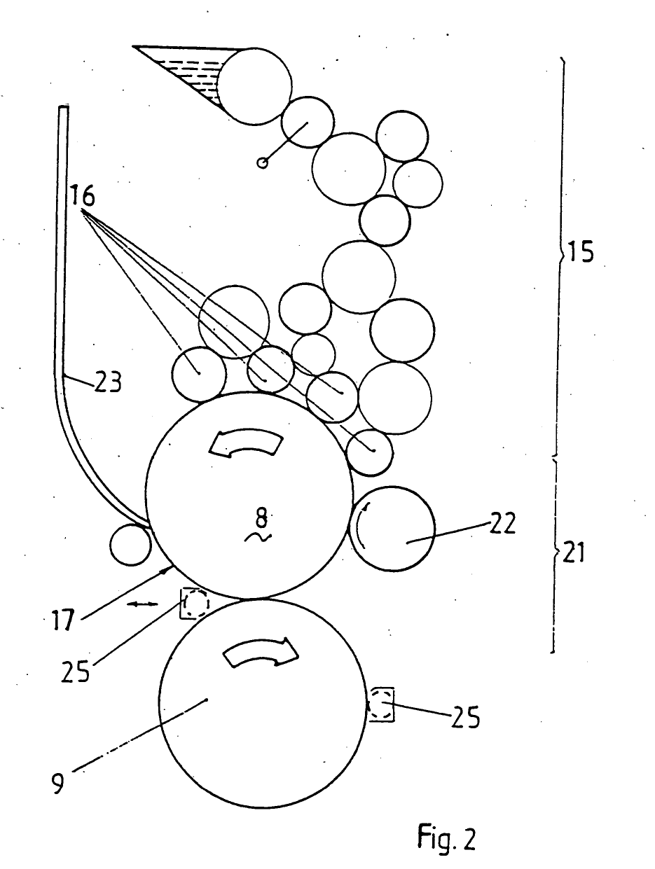

FIG. 2, a coating device for an offset printing group;

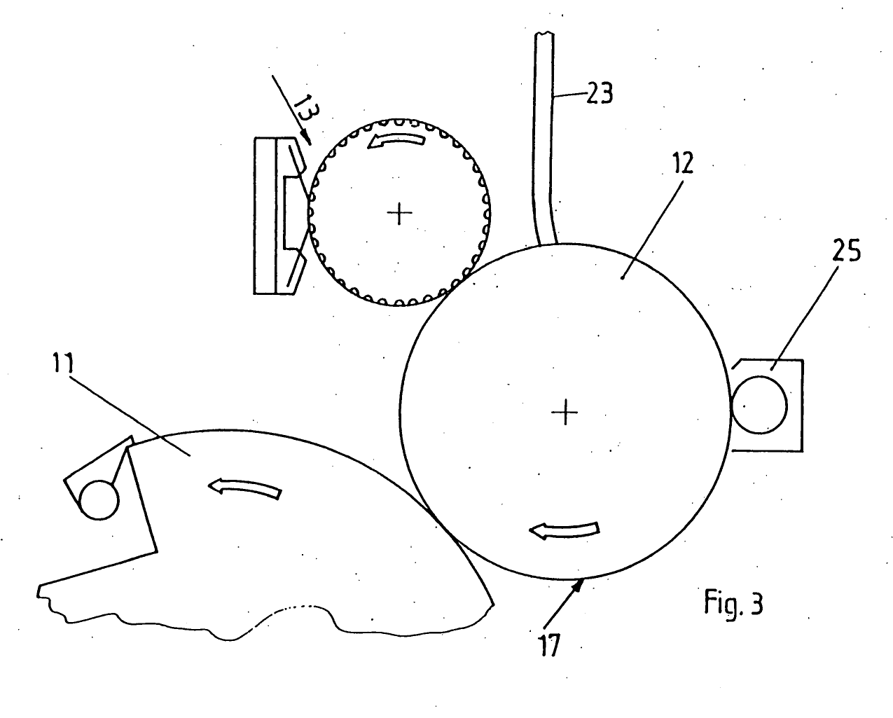

FIG. 3, a coating device for a coating unit, and

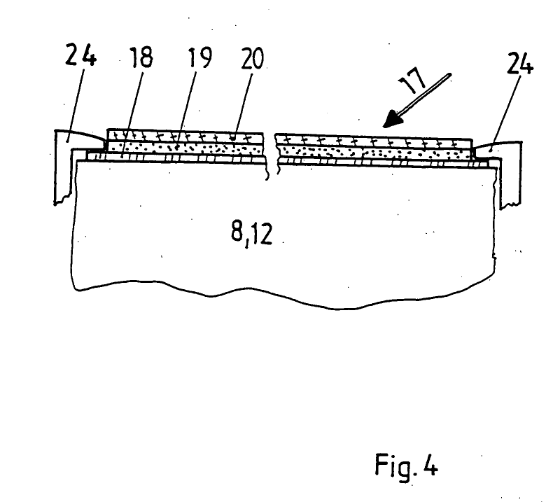

FIG. 4, the structure of a layered body.

A rotary printing machine, for example, a sheet-fed printing machine with several offset printing groups 1, has a serial design, wherein a first coating unit 2 and a second coating unit 3 are arranged downstream of the offset printing groups 1, as viewed in the conveying direction of the sheets to be printed. A drying system 4 is arranged between the coating units 2, 3 in order to dry the sheets being processed. A delivery system 5 is arranged downstream of the second coating unit 3, said delivery system being formed by, among other things, the revolving conveyor system 7 that conveys and deposits the sheets onto a delivery stack 6.

An offset printing group 1 essentially consists of a plate cylinder 8, a rubber blanket cylinder 9 and a printing cylinder 11 that serves as the sheet guiding cylinder. An inking unit 15 with a roller train and inking rollers 16 is associated with the plate cylinder 8. In addition, a moistening unit is, if so required, situated adjacent to the plate cylinder 8; this moistening unit will not discussed in greater detail. A transfer cylinder 10 for conveying the material being printed is arranged, respectively, between the printing groups 1, the coating units 2, 3 and the drying system 4.

The coating unit 2 consists of a printing cylinder 11, a form cylinder 12 that forms the printing gap (coating gap) together with the printing cylinder 11 and carries a layered body 17, as well as a first metering system 13. In the embodiment shown, the first metering system 13 is formed by a screened inking roller that can be brought in contact with the form cylinder 12 and a doctor blade that is functionally connected to this inking roller. Alternatively, it would also be conceivable to utilize metering systems in the form of two-roller units with a coating supply that feeds the coating into the common roll gap from the top (nip roller principle) or roller units with a scoop roller that dips into a reservoir (scoop/dipping roller principle).

The second coating unit 3 consists of the printing cylinder 11 and a form cylinder 12 that forms the printing gap (coating gap) together with the printing cylinder and contains a layered body 17 and a second metering system 14. The second metering system 14 is, for example, realized in the form of a two-roller unit (nip roller principle) that contains an inking roller, as well as a metering roller.

Alternatively, doctor blade systems with a screened inking roller or roller units according to the scoop/dipping roller principle may also be utilized in this case.

The metering systems 13, 14 can be respectively coupled to a separately controllable circuit for circulating the coating liquid.

The coating device for an offset printing group of a rotary printing machine comprises plate clamping devices 24 on the periphery of the plate cylinder 1 in order to hold the layered body 17. The layered body 17 is flexible and consists of a carrier layer 18 that can be held in the plate clamping devices 24 of the plate cylinder 8. A compressible layer 19 that preferably consists of a rubber layer is held on the carrier layer 18. A fixed rubber blanket cover layer 20 is arranged on this compressible layer 19. In this case, the rubber blanket cover layer 20 is functionally connected to the adjacent rubber blanket cylinder 9 of the offset printing group 1.

The coating device for a coating unit 2 and/or 3 of a rotary printing machine comprises plate clamping devices 24 on the periphery of the form cylinder 12 in order to hold the layered body 17. This layered body 17 is flexible and, analogous to the layered body 17 in the offset printing group 1, composed of a carrier layer 18, a compressible layer 19 that preferably consists of a rubber layer and a rubber blanket cover layer 20. In this case, the carrier layer 18 is held in the plate clamping devices 24 of the form cylinder 12, and the rubber blanket cover layer 20 is functionally connected to the adjacent printing cylinder 11 that guides the material to be printed.

The carrier layer 18 preferably consists of a metallic material. Alternatively, the carrier layer 18 at least contains a metallic material. Suitable metallic materials are, in particular, steel or aluminum. It would also be conceivable to utilize plastic materials for the carrier layer 18. The layered body 17 is flexible, and the carrier layer 18, in particular, is dimensionally stable.

The compressible layer 19 preferably contains air inclusions and/or closed air channels in order to improve the damping function.

It is preferred that the layered body 17 can be stripped off at least on the rubber blanket cover layer 20. This means that the layered body 17 can also be utilized for spot coating processes. In the stripped region of the rubber blanket cover layer 20, the compressible layer 19 situated underneath is recessed relative to the plane of the rubber blanket cover layer 20 and consequently does not act as a coating carrier.

The compressible layer 19 preferably is vulcanized onto the carrier layer 18. It is preferred to connect the compressible layer 19 and the rubber blanket cover layer 20 to one another by means of an adhesive connection. The layers 18, 19 and 20 are planar and curve in accordance with the cylinders 8, 12 in the installed state. All layers 18-20 are adhesively connected to one another.

The coating device functions as described below: in an offset printing group 1, a layered body 17 is delivered to the plate cylinder 8, preferably by means of a conventional plate exchanging device 23. Since the layered body 17 is flexible, but its flexibility is not as high as that of a rubber blanket, the delivery and the removal can be realized with the aid of this plate exchanging device 23 in such a way that a stable production is achieved.

If a printing plate was previously held on the plate cylinder 8, this printing plate is initially transferred into the plate exchanging device 23 from the plate cylinder 8. The ends of the carrier layer 18 of the layered body 17 are held on the plate cylinder 8 by means of the plate clamping devices 24.

In this embodiment of the offset printing group 1, it is possible to supply, for example, printer's varnish from the ink fountain via the roller train while the inking rollers 18 are screwed down. If the inking rollers 18 are not screwed down, a separate metering system 21 with at least one inking roller 22 can also be utilized, e.g., as described in DE 197 29 977 A1. This embodiment is particularly suitable for aqueous dispersion coatings. However, the metering system 21 need not necessarily be realized in the form of an enclosed doctor blade system with a screened inking roller (inking roller 21). On the contrary, roller units according to the nip roller principle or the scoop/dipping roller principle could be alternatively utilized. If a moistening unit is provided, a coating supply via the moistening unit could also be realized.

In an offset printing group 1, a layered body 17 is delivered to the plate cylinder 8, preferably by means of a conventional plate exchanging device 23. Since the layered body 17 is flexible, but its flexibility is not as high as that of a conventional rubber blanket, the delivery and the removal can be realized with the aid of this plate exchanging device 23 in such a way that a stable production is achieved.

If a printing plate was previously held on the plate cylinder 8, this printing plate is initially transferred into the plate exchanging device 23 from the plate cylinder 8. The ends of the carrier layer 18 of the layered body 17 are held on the plate cylinder 8 by means of the plate clamping devices 24. In a preferred embodiment, such a carrier layer 18 contains punched-out sections for a conventional registry system at least in the region of the leading rail of a plate clamping device 24.

In the offset printing group 1, it is possible to supply, for example, printer's varnish from the ink fountain via the roller train while the inking rollers 18 are screwed down. If the inking rollers 18 are not screwed down, a separate metering system 21 with at least one inking roller 22 can also be utilized, e.g., as described in DE 197 29 977 A1. This embodiment is particularly suitable for aqueous dispersion coatings. However, the metering system 21 need not necessarily be realized in the form of a doctor blade system with a screened inking roller (inking roller 21). On the contrary, roller units according to the nip roller principle or the scoop/dipping roller principle could be alternatively utilized. If a moistening unit is provided, a coating supply via the moistening unit could also be realized.

In an advantageous embodiment, the layered body 17 held on the plate cylinder 8 can be cleaned by means of a washing device 25 situated adjacent to the rubber blanket cylinder 9. For this purpose, the layered body 17 on the plate cylinder 8 and the rubber blanket on the rubber blanket cylinder 9 are in contact with one another. The layered body 17 is cleaned by means of the washing device 25 and the rubber blanket cylinder 9.

Alternatively, a washing device 25 is assigned to the contact region between the plate cylinder 8 and the rubber blanket cylinder 9. In this embodiment, the washing device 25 can be simultaneously adjusted relative to both cylinders 8, 9 such that the cylinders 8, 9 can be cleaned at the same time. Both arrangements of washing devices 25 are shown in FIG. 2.

In a coating unit 2, 3, one respective layered body 17 is delivered to each form cylinder 12 by means of conventional plate exchanging devices 23 assigned to each unit. Since the layered body 17 is flexible, but its flexibility is not as high as that of a conventional rubber blanket, the delivery and the removal can be realized with the aid of this plate exchanging device 23 in such a way that a stable production is achieved.

If a coating plate, for example, a flexible letterpress printing plate, was previously held on the form cylinder 12, this coating plate is initially transferred into the plate exchanging device 23 from the form cylinder 12. The ends of the carrier layer 18 of the layered body 17 are held on the form cylinder 12 by means of the plate clamping devices 24. In a preferred embodiment, such a carrier layer 18 contains punched-out sections for a conventional registry at least in the region of the leading rail of a plate clamping device 24.

The processing of, for example, aqueous dispersion coatings can be realized in the coating unit 2, 3. Suitable metering systems consist of doctor blade systems with screened inking rollers, as well as alternative roller units according to the nip roller principle or the scoop/dipping roller principle.

In one advantageous embodiment, the layered body 17 held on the form cylinder 12 can be cleaned by means of a washing device 25 situated adjacent to the form cylinder 12.

### List of Reference Symbols

1 Offset printing group

2 Coating unit

3 Coating unit

4 Drying system

5 Delivery mechanism

6 Delivery stack

7 Conveyor system

8 Plate cylinder

9 Rubber blanket cylinder

10 Transfer cylinder

11 Printing cylinder

12 Form cylinder

13 Metering system

14 Metering system

15 Inking unit

16 Inking roller

17 Layered body

18 Carrier layer

19 Compressible rubber layer

20 Rubber blanket cover layer

21 Metering system

22 Inking roller

23 Plate exchanging device

24 Plate clamping device

25 Washing device

1. Coating device for a rotary printing machine with a printing cylinder, a rubber blanket cylinder and a plate cylinder with at least one associated inking unit, wherein the inking rollers of the inking unit can be moved toward and away from the plate cylinder, characterized by the fact that plate clamping devices (24) are arranged on the periphery of the plate cylinder (1) in order to hold a layered body (17), and by the fact that this layered body (17) is flexible and contains a carrier layer (18) that can be held in the plate clamping devices (24), at least one fixed compressible layer (19) that is arranged on the carrier layer (18) and a fixed rubber blanket cover layer (20) that is arranged on this layer (19), wherein the rubber blanket cover layer (20) is functionally connected to the adjacent rubber blanket cylinder (9).

2. Coating device for a rotary printing machine with a printing cylinder, a form cylinder and a metering system with at least one inking roller that is associated with the form cylinder, characterized by the fact that plate clamping devices (24) are arranged on the periphery of the form cylinder (12) in order to hold a layered body (17), and by the fact that this layered body (17) is flexible and contains a carrier layer (18) that can be held in the plate clamping devices (24), at least one fixed compressible layer (19) that is arranged on the carrier layer (18) and a fixed rubber blanket cover layer (20) that is arranged on this layer (19) and functionally connected to the adjacent printing cylinder (13) that guides a material to be printed.

3. Coating device according to claim 1 or 2, characterized by the fact that the carrier layer (18) consists of a metallic material or at least contains a metallic material.

4. Coating device according to claim 3, characterized by the fact that the metallic material of the carrier layer (18) consists of an aluminum material.

5. Coating device according to at least claim 1 or 2, characterized by the fact that the compressible layer (19) consists of a rubber layer and contains air inclusions or air channels.

6. Coating device according to at least claim 1 or 2, characterized by the fact that at least the rubber blanket cover layer (20) can be stripped off.

7. Coating device according to at least claims 1 and 2, characterized by the fact that the compressible rubber layer (19) is vulcanized onto the carrier layer (18).

8. Coating device according to claim 1, characterized by the fact that a plate exchanging device (23) is assigned and situated adjacent to the plate cylinder (8).

9. Coating device according to claim 2, characterized by the fact that a plate exchanging device (23) is associated with and situated adjacent to the form cylinder (12).
